(19) United States
(12) Patent Application Publication
(10) Pub. No.: US 2007/0189734 A1
(43) Pub. Date: Aug. 16, 2007

(54) Packet recording and playback apparatus

(75) Inventors: Hiroaki Yamamoto, Fukuoka (JP); Wataru Nakamura, Fukuoka (JP); Tetsuya Inoue, Fukuoka (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki-shi (JP)

(21) Appl. No.: 11/698,855

(22) Filed: Jan. 29, 2007

(30) Foreign Application Priority Data
Feb. 2, 2006 (JP) 2006-026255

(51) Int. Cl. H04N 7/26

(52) U.S. Cl. 386/112

(57) ABSTRACT

A packet recoding and playback apparatus capable of generating an actual volume of traffic on a network. A packet reception unit receives a packet flowing on the network. A time generator generates a time. A packet storing unit stores the packet received by the packet reception unit, in a memory unit together with the time of reception of the packet. When a packet stored in the memory unit is played on the network, a packet playback unit plays the packet at a timing corresponding to the reception of the packet, based on the time stored together with the packet in the memory unit.

### CROSS-REFERENCE TO RELATED APPLICATIONS

This application is based upon and claims the benefits of priority from the prior Japanese Patent Application No. 2006-026255, filed on Feb. 2, 2006, the entire contents of which are incorporated herein by reference.

### BACKGROUND OF THE INVENTION

(1) Field of the Invention

This invention relates to a packet recording and playback apparatus, and particularly to a packet recording and playback apparatus for recording and playing packets.

(2) Description of the Related Art

Conventionally, there is a packet recording and playback apparatus that records packets flowing on a network and plays the packets. This packet recording and playback apparatus can be used for verifying effects of traffic on devices existing on a network by recording packets on the network and playing the packets.

On the other hand, there has been provided a packet communication method for enabling optimal video transmission by transmitting and receiving time information in communication between video terminals to calculate throughput that dynamically varies between the video terminals and controlling an encoding rate based on the calculation result (For example, refer to Japanese Unexamined Patent Publication No. 6-125363).

For playback of packets, such conventional packet recording and playback apparatus can generate a desirably specified volume of traffic, but cannot generate an actual volume of traffic on a network. Therefore, there has been demanded a packet recording and playback apparatus capable of generating an actual volume of traffic on a network.

In addition, Japanese Unexamined Patent Publication No. 6-125363 is directed to enabling optimal video transmission by controlling an encoding rate between video terminals but does not teach generating an actual volume of traffic on a network.

### SUMMARY OF THE INVENTION

This invention has been made in view of foregoing and intends to a packet recording and playback apparatus that enables generating an actual volume of traffic on a network.

To accomplish the above problem, there has been provided a packet recording and playback apparatus for recording and playing packets. This recording and playback apparatus comprises: a packet reception unit for receiving a packet flowing on a network; a time generator for generating a time; a packet storing unit for storing the received packet together with the time of reception of the packet in a memory unit; and a packet playback unit for playing the packet stored in the memory unit, on the network at a timing corresponding to the reception of the packet based on the time of the reception.

The above and other objects, features and advantages of the present invention will become apparent from the following description when taken in conjunction with the accompanying drawings which illustrate preferred embodiments of the present invention by way of example.

### BRIEF DESCRIPTION OF THE DRAWINGS

FIG. 1 shows an outline of a packet recording and playback apparatus.

FIG. 2 shows an example configuration of a network to which the packet recording and playback apparatus is implemented.

FIG. 3 is a block diagram of the hardware of the packet recording and playback apparatus.

FIG. 4 shows an example structure of data in a filtering table (TB).

FIG. 5 is an example structure of data in a reception buffer memory.

FIG. 6 is an example structure of data in a packet management TB.

FIG. 7 is an example structure of data in a Hard Disk Drive (HDD).

FIG. 8 is a flowchart showing a recording operation of the packet recording and playback apparatus.

FIG. 9 is a flowchart showing a playback operation of the packet recording and playback apparatus.

FIG. 10 is a flowchart showing an operation for the time of transmitting TCP data.

FIG. 11 is a flowchart showing an operation for the time of receiving TCP data.

### DESCRIPTION OF THE PREFERRED EMBODIMENTS

Preferred embodiments of this invention will be described with reference to the accompanying drawings.

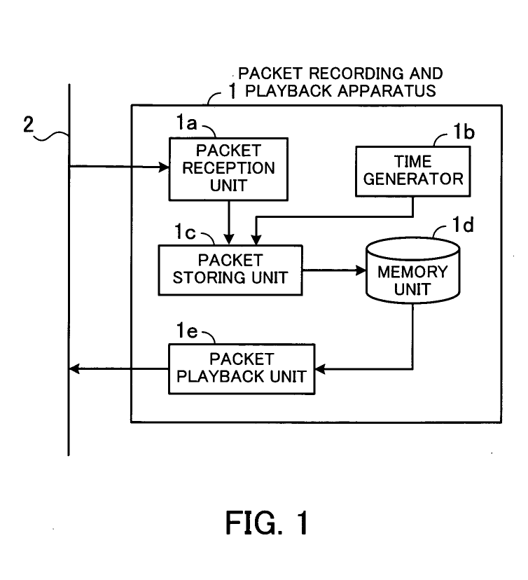

FIG. 1 shows an outline of a packet recording and playback apparatus. Referring to FIG. 1, this packet recording and playback apparatus 1 is connected to a network 2, and comprises a packet reception unit 1a, a time generator 1b, a packet storing unit 1c, a memory unit id, and a packet playback unit 1e.

The packet reception unit 1a receives a packet flowing on the network 2. The time generator 1b generates a time. The packet storing unit 1c stores the received packet together with the time of reception of the packet in the memory unit 1d. When a packet stored in the memory unit 1d is played on the network 2, the packet playback unit 1e plays the packet at a timing corresponding to the reception of the packet, based on the time of reception stored together with the packet. For example, the packet playback unit 1e calculates a difference between the time of reception of a previous packet that was played last time and the time of reception of the current packet to be played this time. When the calculated differential time has passed after the previous packet was played, the packet playback unit 1e plays the current packet on the network 2, thereby playing the packet at a timing corresponding to the reception of the packet.

As described above, a received packet is stored in the memory unit id together with its receiving time. Then to play the packet stored in the memory unit id, the packet is played at a timing corresponding to the reception of the packet, based on the receiving time stored together with the packet. Thus an actual volume of traffic on the network can be generated.

One embodiment of this invention will now be described in detail.

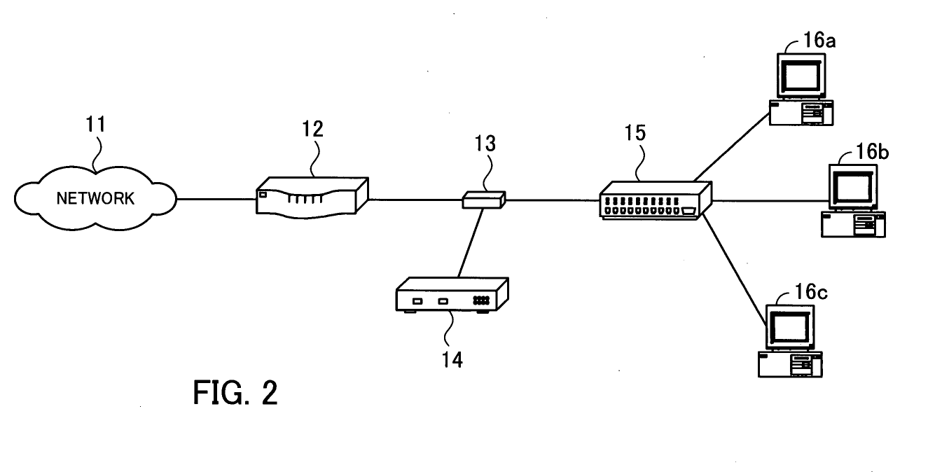

FIG. 2 shows an example configuration of a network to which the packet recording and playback apparatus is implemented. Referring to FIG. 2, a router/switch 15 and terminals 16a to 16c are connected to a network 11 via the network connection device 12. A tap 13 is provided between a network connection device 12 and the router/switch 15, and is connected to the packet recording and playback apparatus 14.

The packet recording and playback apparatus 14 is capable of recording packets flowing on the network and playing the packets. In this figure, the packet recording and playback apparatus 14 records packets flowing between the network connection device 12 and the router/switch 15, and plays the packets.

When recording a packet flowing on the network, the packet recording and playback apparatus 14 records the receiving time of the packet together. The packet recording and playback apparatus 14 plays the recorded packet on the network based on the receiving time of the packet, thus making it possible to generate an actual volume of traffic on the network.

The packet recoding and playback apparatus 14 of FIG. 2 will be described in detail next.

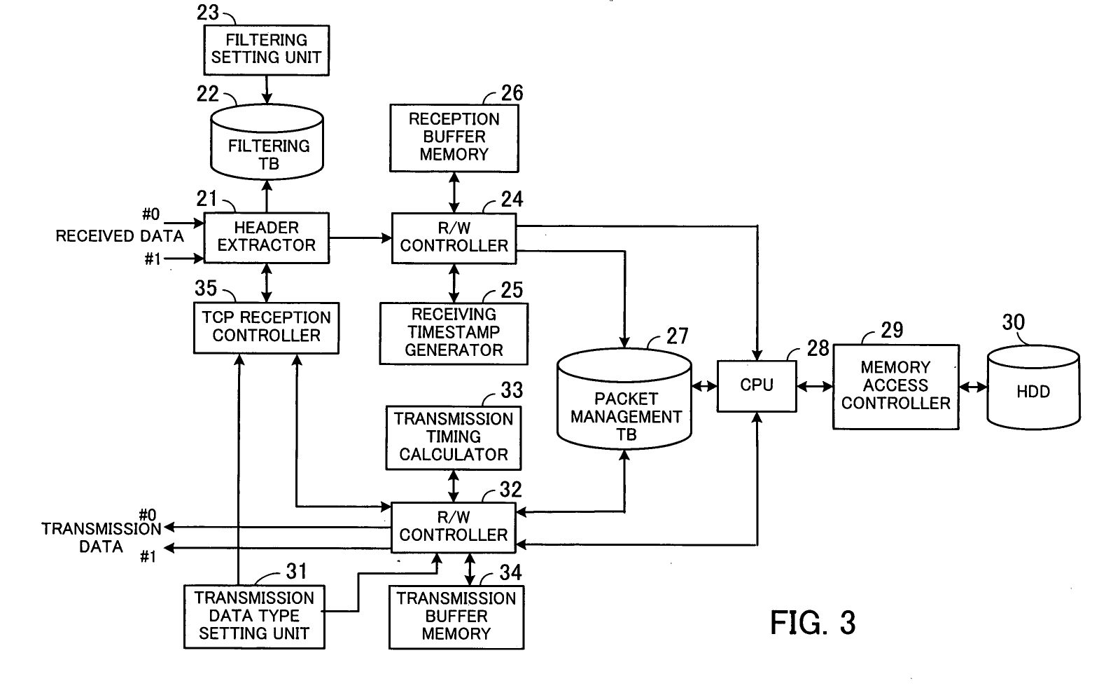

FIG. 3 is a block diagram of the hardware of the packet recording and playback apparatus. Referring to FIG. 3, the packet recording and playback apparatus 14 comprises a header extractor 21, a filtering table (TB) 22, a filtering setting unit 23, a Read/Write (R/W) controllers 24 and 32, a receiving timestamp generator 25, a reception buffer memory 26, a packet management TB 27, a Central Processing Unit (CPU) 28, a memory access controller 29, a Hard Disk Drive (HDD) 30, a transmission data type setting unit 31, a transmission timing calculator 33, a transmission buffer memory 34, and a Transmission Control Protocol (TCP) reception controller 35.

To the header extractor 21, packets (received data) flowing on the network are input. “#0”, “#1” of received data shown in FIG. 3 indicates an arrival direction of the received data. For example, “#0” indicates that a packet has arrived from the network connection device 12 of FIG. 2 and “#1” indicates that a packet has arrived from the router/switch 15.

The header extractor 21 extracts header information of received data, and determines whether the extracted header information has been registered in the filtering TB 22. If the header information has been registered in the filtering TB 22, the header extractor 21 gives the received data to the R/W controller 24. In addition, if the received data is a TCP packet, the header extractor 21 also gives the received data to the TCP reception controller 35.

The filtering TB 22 contains information on received data to be recorded in the packet recording and playback apparatus 14.

The filtering setting unit 23 changes information registered in the filtering TB 22 according to user commands. That is, a user can set which received data should be recorded in the packet recording and playback apparatus 14.

The filtering TB 22 will now be described in detail.

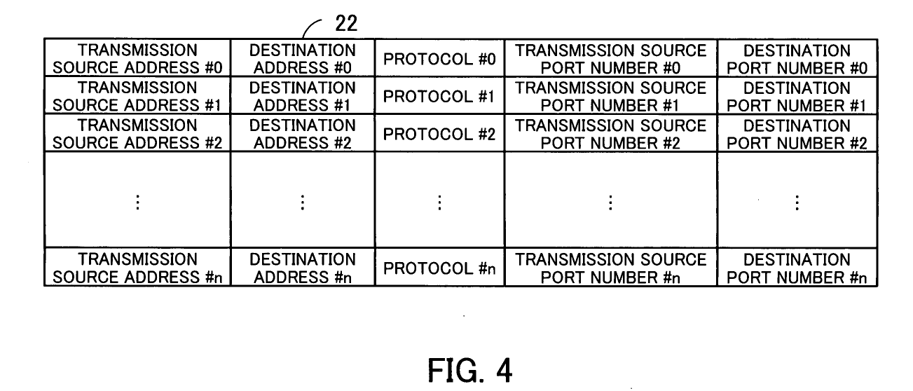

FIG. 4 shows an example structure of data in the filtering TB. Referring to FIG. 4, the filtering TB 22 contains information on data to be recorded, including transmission source addresses #0 to #n, destination addresses #0 to #n, protocols #0 to #n, transmission source port numbers #0 to #n, and destination port numbers #0 to #n.

As the transmission source addresses #0 to #n, the IP addresses of transmission sources of received data to be recorded in the packet recording and playback apparatus 14 are set, for example. As the destination addresses #0 to #n, the IP addresses of destinations of received data to be recorded in the packet recording and playback apparatus 14 are set, for example.

As the protocols #0 to #n, the protocols of received data to be recorded in the packet recording and playback apparatus 14, such as TCP, User Datagram Protocol (UDP), and Internet Control Message Protocol (ICMP) are set, for example.

As the transmission source port numbers #0 to #n, the port numbers of transmission sources of received data to be recorded in the packet recording and playback apparatus 14 are set, for example. As the destination port numbers #0 to #n, the port numbers of destinations of received data to be recorded in the packet recording and playback apparatus 14 are set, for example.

In the filtering TB 22, information arranged in a row is associated with each other. For example, if the header information of received data extracted by the header extractor 22 includes transmission source address #0, destination address #0, protocol #0, transmission source port number #0, and destination port number #0, for example, the header extractor 21 outputs the received data to the R/W controller 24. That is to say, received data inputted to the header extractor 21 is filtered with reference to the filtering TB 22.

Referring back to FIG. 3, the R/W controller 24 stores received data received from the header extractor 21, in the reception buffer memory 26. When storing the received data in the reception buffer memory 26, the R/W controller 24 obtains the current time (hereinafter, referred to as timestamp) from the receiving timestamp generator 25, and stores the timestamp together. That is, the R/W controller 24 stores the received data together with the receiving time of the received data in the reception buffer memory 26. In order to simplify write and read control of received data, the R/W controller 24 determines a write address so as to align the boundary, and stores the received data in the reception buffer memory 26.

When the R/W controller 24 stores the received data in the reception buffer memory 26, the R/W controller 24 stores information on the stored received data in the packet management TB 27. Specifically, the R/W controller 24 stores in the packet management TB 27 the start address, protocol type, and timestamp of the received data stored in the reception buffer memory 26, and information indicating that the received data has been stored in the reception buffer memory 26.

The receiving timestamp generator 25 counts a time. The receiving timestamp generator 25 outputs a timestamp to the R/W controller 24 in response to a request therefrom.

The reception buffer memory 26 is a memory for storing received data. The reception buffer memory 26 may be a Random Access Memory (RAM) for example, and has a capacity of 512 MB or 1 GB.

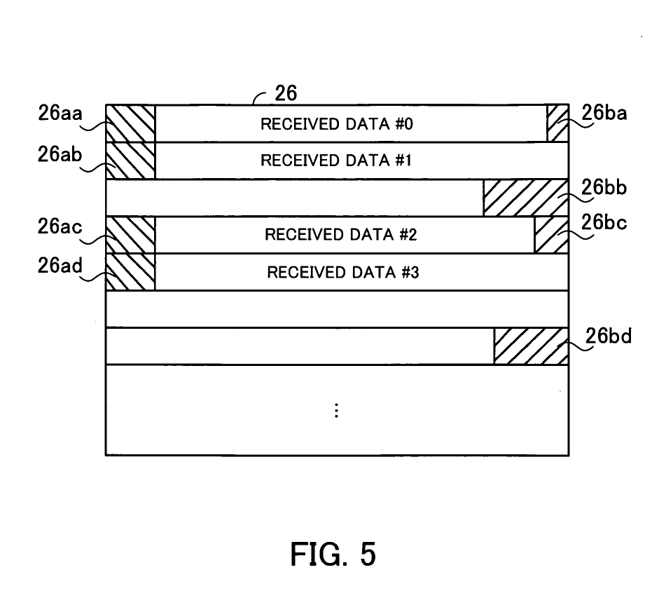

An example data structure of received data stored in the reception buffer memory 26 will now be described with reference to FIG. 5.

Referring to FIG. 5, the reception buffer memory 26 stores received data #0 to #3 . . . . As described earlier, the received data #0 to #3 . . . is stored together with timestamps 26aa to 26ad . . . in the reception buffer memory 26. The timestamps 26aa to 26ad . . . are added to the beginning of the received data #0 to #3 . . . as shown in FIG. 5, for example.

The received data #0 to #3 . . . is stored so as to align the boundary, as described earlier. For this reason, there may be generated free space 26ba to 26bd . . . between the received data #0 to #3 . . . .

Referring back to FIG. 3, the packet management TB 27 contains information on received data stored in the reception buffer memory 26, as described earlier. In addition, the packet management TB 27 contains information on received data stored on the HDD 30 and information on data (transmission data) that is stored in the transmission buffer memory 34 for playback, which will be described later.

The packet management TB 27 will now be described in detail.

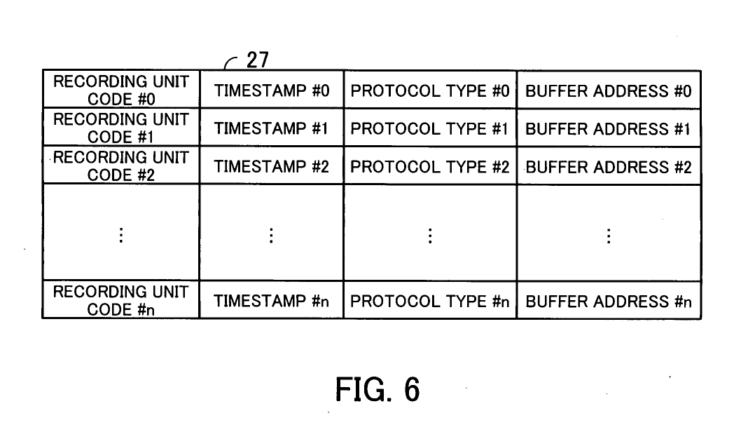

FIG. 6 shows an example structure of data in the packet management TB 27. Referring to FIG. 6, the packet management TB 27 contains recording unit codes #0 to #n, timestamps #0 to #n, protocol types #0 to #n, and buffer addresses #0 to #n.

In the packet management TB 27, information arranged in a row is associated with each other. For example, information of one row (information of one entry) in FIG. 6 indicates information on received data stored in the reception buffer memory 26, information on received data stored on the HDD 30, or information on transmission data stored in the transmission buffer memory 34. That is to say, information of one entry indicates information on a single packet.

A recording unit code #0 to #n indicates which memory stores received data, the reception buffer memory 26, the HDD 30, or the transmission buffer memory 34. A timestamp #0 to #n is a timestamp added to received data. A protocol type #0 to #n indicates the protocol of received data. A buffer address #0 to #n indicates the start address of received data stored in the reception buffer memory 26, the HDD 30, or the transmission buffer memory 34.

As described above, the packet management TB 27 contains information on which memory unit (reception buffer memory 26, the HDD 30, or the transmission buffer memory 34 in the example of FIG. 3) stores received data and which start address the received data is stored from. In addition to the information, the timestamp and protocol type of the received data are stored.

Referring back to FIG. 3, the CPU 28 consults the packet management TB 27 to determine whether the reception buffer memory 26 is full of received data. For example, the CPU 28 makes this determination based on the buffer addresses #0 to #n of a corresponding recording unit code #0 to #n indicating storage into the reception buffer memory 26, in the packet management TB 27 of FIG. 6.

If the CPU 28 determines based on the packet management TB 27 that the reception buffer memory 26 is full of received data, the CPU 28 receives received data with a timestamp added thereto, from the R/W controller 24, and stores it on the HDD 30 via the memory access controller 29. At this time, the CPU 28 stores the received data together with the receiving time on the HDD 30.

When the CPU 28 stores the received data on the HDD 30, the CPU 28 stores information on the stored received data in the packet management TB 27. Specifically, the CPU 28 stores in the packet management TB 27 of FIG. 6, the start address, protocol type, and timestamp of the received data stored on the HDD 30, and information indicating that the received data has been stored on the HDD 30.

In addition, the CPU 28 consults the packet management TB 27 based on user-specified information on a packet to be played, to obtain information on received data to be played. The CPU 28 acquires the data (transmission data) to be played from the reception buffer memory 26 or the HDD 30, based on the information obtained from the packet management TB 27, and outputs the acquired transmission data to the R/W controller 32.

It is now assumed that the user specifies playback of UDP data. The CPU 28 consults the packet management TB 27 to obtain the buffer addresses #0 to #n of protocol type #0 to #n indicating UDP. The CPU 28 recognizes based on the recording unit codes #0 to #n of the packet management TB 27 whether the obtained buffer addresses #0 to #n are addresses of the reception buffer memory 26 or the HDD 30, and acquires the data (transmission data) from the reception buffer memory 26 or the HDD 30. The CPU 28 outputs the obtained transmission data to the R/W controller 32.

It should be noted that received data has header information and the header information includes the data length of the received data. The CPU 27 recognizes the length of the received data to be acquired, from the start address of the received data and the data length included in the header information. In the case where received data is stored in the reception buffer memory 26 or the HDD 30 in increasing order of address, the CPU 28 acquires the received data in order from the smallest buffer address #0 to #n. Thereby the received data can be played in order of reception.

The memory access controller 29 stores the received data received from the CPU 29, on the HDD 30. It should be noted that a memory unit for storing received data is not limited to the HDD 30 and also a flash memory can be used, for example. The HDD 30 has a capacity of several tens GB, for example.

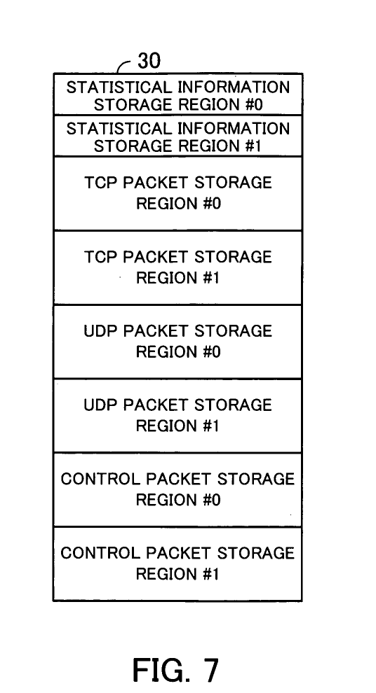

FIG. 7 shows an example structure of data in the HDD. Referring to FIG. 7, the HDD 30 has statistical information storage regions #0 and #1, TCP packet storage regions #0 and #1, UDP packet storage regions #0 and #1, and control packet storage regions #0 and #1. #0, #1 in FIG. 7 indicates an arrival direction of a packet (received data).

In the statistical information storage regions #0 and #1, the CPU 28 stores the number of received data received by the header extractor 21 and the number of received data received in failure. The TCP packet storage regions #0 and #1 store TCP packets (received data). The UDP packet storage regions #0 and #1 store UDP packets. The control packet storage regions #0 and #1 store ICMP packets, for example.

Referring back to FIG. 3. The transmission data type setting unit 31 receives user setting of information on data to be played. For example, the protocol type (TCP, UDP, or the like) of data to be played is specified by the user. The transmission data type setting unit 31 outputs the setting information to the R/W controller 32 and the TCP reception controller 35.

The R/W controller 32 notifies the CPU 28 of the information set in the transmission data type setting unit 31. The CPU 28 acquires the data (transmission data) to be played, from the reception buffer memory 26 or the HDD 30, based on the information given from the R/W controller 32, as described above, and outputs the data to the R/W controller 32. The R/W controller 32 stores the transmission data received from the CPU 28, in the transmission buffer memory 34.

When storing the transmission data in the transmission buffer memory 34, the R/W controller 32 stores information on the stored transmission data in the packet management TB 27. Specifically, the R/W controller 32 stores in the packet management TB 27 of FIG. 6, the start address, protocol type, and timestamp of the transmission data stored in the transmission buffer memory 34, and information indicating that the transmission data has been stored in the transmission buffer memory 34.

In order to output (play) transmission data stored in the transmission buffer memory 34 to the network, the R/W controller 32 consults the packet management TB 27 to read the transmission data. The R/W controller 32 outputs the read transmission data to the transmission timing calculator 33. The transmission timing calculator 33 instructs the R/W controller 32 when to output the transmission data to the network, which will be described later. The R/W controller 32 outputs the transmission data read from the transmission buffer memory 34, to the network in accordance with the instruction of the transmission timing calculator 33.

In the case where TCP is set in the transmission data type setting unit 31, the R/W controller 32 outputs transmission data in accordance with an instruction from the transmission timing calculator 33 and an instruction from the TCP reception controller 35, which will be described later.

In this connection, #0, #1 of transmission data shown in FIG. 3 indicates an output direction of the transmission data. For example, #0 indicates that transmission data is to be output to the network connection device 12 of FIG. 2, and #1 indicates that transmission data is to be output to the router/switch 15.

The transmission timing calculator 33 receives transmission data from the R/W controller 32, and extracts the timestamp included in the transmission data. The transmission timing calculator 33 calculates a difference between the timestamp included in previous transmission data received from the R/W controller 32 last time and the timestamp included in the current transmission data received from the R/W controller 32 this time. That is to say, the transmission timing calculator 33 calculates a time of when to output the current transmission data to the network after the previous transmission data was output to the network last time. When the calculated differential time has passed after the previous transmission data was output to the network, the transmission timing calculator 33 notifies the R/W controller 32 that the output timing of the current transmission data has come.

It should be noted that the transmission timing calculator 33 calculates a timing of outputting transmission data, based on the timestamps included in transmission data in the above described way. Therefore, the packet management TB 27 is unnecessary to store timestamps.

The transmission buffer memory 34 is a memory for storing transmission data. The transmission buffer memory 34 is a memory unit such as RAM, for example. The transmission buffer memory 34 has a capacity of 512 MB or 1 GB, for example. Similarly to the reception buffer memory 26, the transmission buffer memory 34 stores transmission data so as to align the boundary.

In the case where TCP is set in the transmission data type setting unit 31, the TCP reception controller 35 obtains a TCP packet from the header extractor 21 to receive a response to transmission data from a communicating party.

The TCP reception controller 35 confirms a response status to the transmission data, based on the header information of a packet received from the header extractor 21, and determines whether next transmission data can be transmitted or an error has occurred. If it is determined that next transmission data can be transmitted, the TCP reception controller 35 notifies the R/W controller 32 of this matter. In the case where the R/W controller 32 has received this notification from the TCP reception controller 35 and an output timing of the transmission data has come, the R/W controller 32 outputs the transmission data to the network. In the case where the R/W controller 32 has not received such notification from the TCP reception controller 35, even if the output timing of the transmission data has come, the R/W controller 32 does not output the transmission data to the network.

If an error has occurred, the TCP reception controller 35 notifies the CPU 28 of this matter, so as to interrupt a sequence of TCP sessions. As described above, even in the case where the protocol is TCP, playback allowing to keep a TCP sequence can be realized.

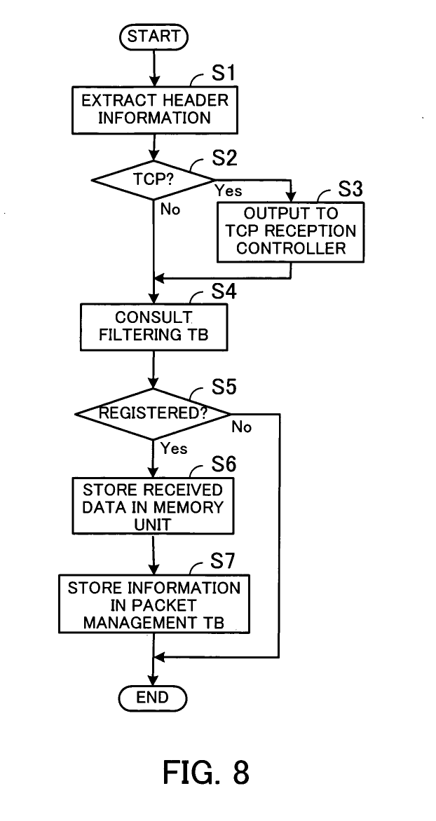

The operation of the packet recording and playback apparatus will be described with reference to flowcharts. The recording operation of the packet recording and playback apparatus will be first described with reference to a flowchart of FIG. 8. The packet recording and playback apparatus executes the recording operation in accordance with the following steps every time when it receives data.

[Step S1] The header extractor 21 extracts header information of received data.

[Step S2] The header extractor 21 determines based on the extracted header information whether the received data is a TCP packet or not. If the received data is a TCP packet, the operation goes on to step S3, and otherwise goes on to step S4.

[Step S3] The header extractor 21 outputs the received data to the TCP reception controller 35. The operation goes on to step S4.

[Step S4] The header extractor 21 consults the filtering TB 22 based on the extracted header information.

[Step S5] The header extractor 21 determines whether the extracted header information has been registered in the filtering TB 22. If the extracted header information exists in the filtering TB 22, the operation goes on to step S6, and otherwise the operation is completed.

[Step S6] The header extractor 21 outputs the received data to the R/W controller 24. The R/W controller 24 obtains a timestamp from the receiving timestamp generator 25, adds the timestamp to the received data, and stores the received data in the reception buffer memory 26. In this connection, if the reception buffer memory 26 is full of received data, the CPU 28 receives the received data from the R/W controller 24 and stores it on the HDD 30.

[Step S7] The R/W controller 24 stores information on the received data stored in the reception buffer memory 26 in the packet management TB 27. In the case where the received data is stored on the HDD 30, the CPU 28 stores information on the received data stored on the HDD 30, in the packet management TB 27.

As described above, the received data is stored with a timestamp added thereto, in the reception buffer memory 26 or the HDD 30. In addition, the information on the received data stored in the reception buffer memory 26 or the HDD 30 is stored in the packet management TB 27.

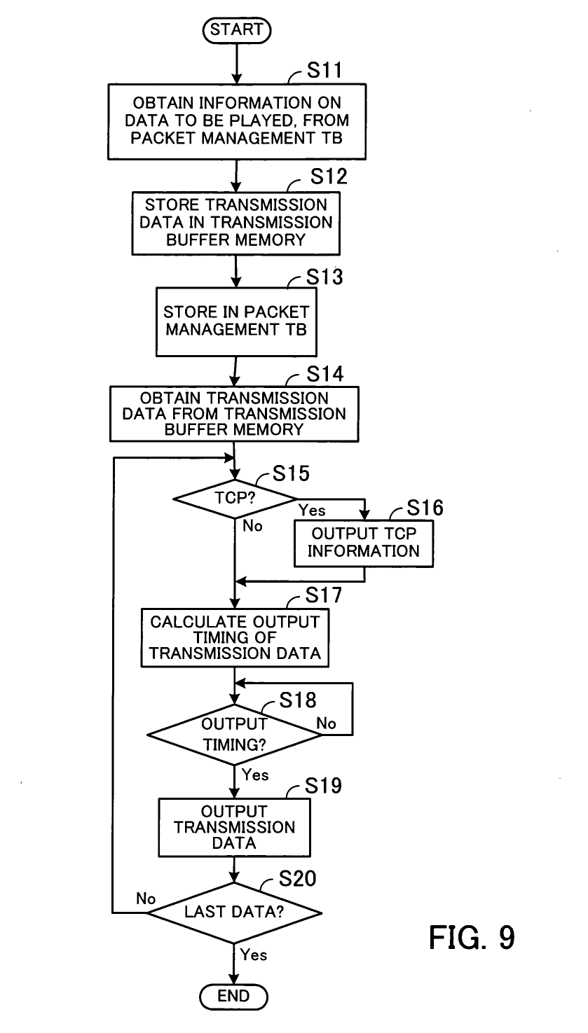

The playback operation of the packet recording and playback apparatus will be described next with reference to a flowchart of FIG. 9. The packet recording and playback apparatus outputs transmission data to a network in accordance with the following steps.

[Step S11] The CPU 28 obtains information on data corresponding to information set in the transmission data type setting unit 31 (information indicating which memory unit stores the data at which addresses), from the packet management TB 27.

[Step S12] The CPU 28 acquires the data (transmission data) to be played from the reception buffer memory 26 or the HDD 30 based on the information obtained from the packet management TB 27, and outputs the transmission data to the R/W controller 32. The R/W controller 32 stores the received transmission data in the transmission buffer memory 34.

[Step S13] After storing the transmission data in the transmission buffer memory 34, the R/W controller 32 stores information on the transmission data stored in the transmission buffer memory 34 in the packet management TB 27.

[Step S14] The R/W controller 32 consults the packet management TB 27 to read the transmission data from the transmission buffer memory 34.

[Step S15] The R/W controller 32 determines whether TCP is set in the transmission data type setting unit 231. If TCP is set, the operation goes on to step S16, and otherwise goes on to step S17.

[Step S16] If the segment of the TCP transmission data read from the transmission buffer memory 34 is not ACKnowledge (ACK), the R/W controller 32 outputs the IP address and port number of the transmission data to the TCP reception controller 35.

[Step S17] The transmission timing calculator 33 receives the transmission data from the R/W controller 32, and calculates an output timing of the transmission data.

[Step S18] The transmission timing calculator 33 determines whether the output timing of outputting the transmission data to the network has come. If the output timing has come, the operation goes on to step S19.

[Step S19] The R/W controller 32 receives a notification of the output timing from the transmission timing calculator 33, and outputs the transmission data to the network. At this time, in the case where TCP is set in the transmission data type setting unit 31, the R/W controller 32 does not output the transmission data to the network unless it does not receive a notification from the TCP reception controller 35.

[Step S20] The R/W controller 32 consults the packet management TB 27 to determine whether the transmission data is the last data. If the data is not the last data, then the operation goes on to step S15.

As described above, the output timing of transmission data is calculated based on the timestamp that was added to the transmission data and stored in the memory unit, and the transmission data is output to the network at the output timing. Thereby an actual volume of traffic on the network can be generated.

Now, the operation for the time of transmitting and receiving TCP packets will be described.

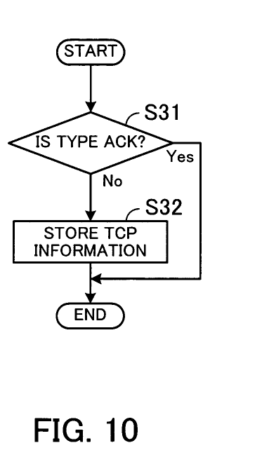

FIG. 10 is a flowchart showing an operation for the time of transmitting TCP data. The following operation describes the details of step S16 of FIG. 9.

[Step S31] The R/W controller 32 determines whether the segment of the TCP transmission data read from the transmission buffer memory 34 is ACK or not. If the segment is not ACK, the R/W controller 32 outputs the IP address and port number of the transmission data and a TCP status indicating the current communication status to the TCP reception controller 35.

[Step S32] The TCP reception controller 35 stores the IP address and port number of the transmission data and the TCP status, which were received from the R/W controller 32, in, for example, its own memory unit.

As described above, if the transmission data is not an ACK packet to be returned to the communicating party, the TCP reception controller 35 stores the IP address and port number of the transmission data, and the TCP status in the memory unit for later use to confirm a response to the transmission data from the communicating party.

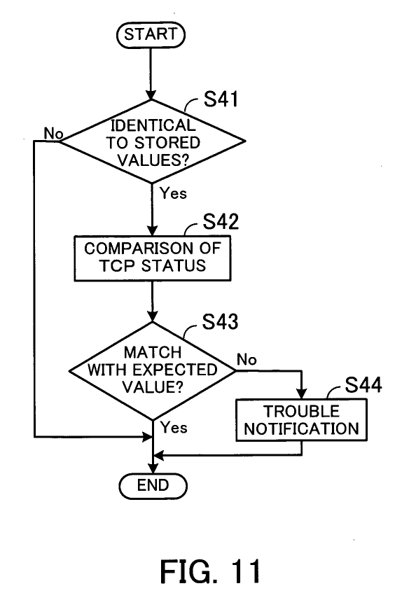

FIG. 11 is a flowchart showing the operation for the time of receiving TCP data. The following operation describes the details of step S3 of FIG. 8.

[Step S41] The TCP reception controller 35 determines whether the IP address and port number of the TCP data received by the header extractor 21 are identical to the IP address and port number stored in the memory unit. If they are identical, the operation goes on to step S42, and otherwise the operation is completed.

[Step S42] The TCP reception controller 35 compares the TCP code bit included in the received data with a next TCP status expected from the TCP status stored in the memory unit.

[Step S43] The TCP reception controller 35 determines whether the TCP code bit included in the received data matches the next TCP status expected from the TCP status stored in the memory unit. If they match, the operation is completed. The TCP reception controller 35 proceeds to a next TCP sequence. If they do not match, the operation goes on to step S44.

[Step S44] The TCP reception controller 35 notifies the CPU 28, for example, via the R/W controller 32 that an error has occurred in the TCP sequence.

In the above-described way, packets can be recorded and played with keeping a TCP sequence.

As explained so far, received data is stored together with its receiving time in the reception buffer memory 26 or the HDD 30. Then when data stored in the reception buffer memory 26 or the HDD 30 is played, a difference between the receiving time of previous data that was played last time and the receiving time of the current data to be played this time is calculated, and when the differential time has passed after the previous data was played, the current data is output to the network. Thereby the data (transmission data) can be output at a timing corresponding to reception of the data, thus making it possible to generate an actual volume of traffic on the network.

Further, a network system or a network-relevant device can be verified under an actual traffic generated.

According to the packet recoding and playback apparatus of this invention, a received packet is stored together with its receiving time in a memory unit, and when the received packet is played, the received packet is played at a timing corresponding to the reception of the received packet, based on the receiving time stored together with the received packet. Thereby an actual volume of traffic on the network can be generated.

The foregoing is considered as illustrative only of the principle of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

What is claimed is:

1. A packet recording and playback apparatus for recoding and playing a packet; comprising:
packet reception means for receiving the packet flowing on a network;
time generation means for generating a time;
packet storing means for storing the packet received, together with the time of reception of the packet in a memory unit
packet playback means for playing the packet stored in the memory unit, on the network at a timing corresponding to the reception of the packet based on the time of the reception.

2. The packet recording and playback apparatus according to claim 1, wherein the packet playback means calculates a difference between a time of a previous packet that was played last time and the time of the packet to be played this time, and plays the packet when the differential time has passed after the previous packet was played.

3. The packet recording and playback apparatus according to claim 1, wherein the packet reception means receives the packet including information specified by a user.

4. The packet recording and playback apparatus according to claim 1, further comprising a packet management table having an address of the packet stored in the memory unit and packet information on the packet, wherein the packet playback means obtains the address from the packet management table according to the packet information specified by a user for playback, and acquires the packet to be played, from the memory unit based on the obtained address.

5. The packet recording and playback apparatus according to claim 4, wherein, if there is a plurality of the memory units, the packet management table also has information on the plurality of the memory units.

6. The packet recording and playback apparatus according to claim 4, wherein the packet information is a protocol of the packet.

7. The packet recording and playback apparatus according to claim 1, further comprising a Transmission Control Protocol (TCP) control means for, in a case where a protocol of the packet to be played is TCP, playing the packet so as to keep a TCP sequence.

8. The packet recording and playback apparatus according to claim 7, wherein the TCP control means detects an error in TCP communication based on a response status received from a communicating party that receives the packet played.
